(19) United States
(12) Patent Application Publication
(10) Pub. No.: US 2026/0252794 A1
(43) Pub. Date: Aug. 27, 2026

(54) SKIPPING AUTOCORRECT IN TEXT INDICATING A TYPOGRAPHICAL ERROR

(71) Applicant: Motorola Mobility LLC, Chicago, IL (US)

(72) Inventors: Amit Kumar Agrawal, Bangalore (IN); Partha Pratim Jana, Bengaluru (IN); Bhashyam Krishnama Naidu Sukumar, Bangalore (IN)

(73) Assignee: Motorola Mobility LLC, Chicago, IL (US)

(21) Appl. No.: 19/063,948

(22) Filed: Feb. 26, 2025

(51) Int. Cl. G06F 40/232; G06F 40/30

(52) U.S. Cl. CPC G06F 40/232; G06F 40/30

(57) ABSTRACT

In aspects of skipping autocorrect in text indicating a typographical error, a computing device implements a text processing application that is operable to monitor text input for a typographical error in a draft message. The computing device may detect that the typographical error is intended in the draft message, and maintain the typographical error in the draft message without auto-correction.

### BACKGROUND

Computing devices such as smart devices, mobile devices (e.g., cellular phones, tablet devices, smartphones), computer devices, consumer electronics, and the like can be implemented for use in a wide range of environments and for a variety of different applications. Many of these types of devices include word processors, email applications, and various messaging applications, any one or more of which includes integrated spellcheck and autocorrect features. Spelling mistakes are quite common in everyday writing, as people often type quickly, get distracted, or are unfamiliar with certain words. Given the ubiquity of conventional digital communication, spelling errors often occur in emails, documents, presentations, and even informal messages. These spelling errors may undermine the professionalism and/or intended clarity of a message, and may also reflect poorly on the drafter of a message or document.

The spellcheck and autocorrect features integrated in word processors, email applications, and various messaging applications, can help a drafter by quickly detecting and flagging spelling errors, offering corrections, and even predicting an intended word. Today's spellcheck and autocorrect features have become essential and are relied on by users to maintain spelling and grammar accuracy, and to improve their writing. The benefits may include reducing the cognitive load on a user while drafting content, allowing the user to focus more on the content creation rather than worrying about the small or precise spelling details.

### BRIEF DESCRIPTION OF THE DRAWINGS

Implementations of the techniques for skipping autocorrect in text indicating a typographical error are described with reference to the following Figures. The same numbers may be used throughout to reference like features and components shown in the Figures.

FIG. 1 illustrates an example system for skipping autocorrect in text indicating a typographical error in accordance with one or more implementations as described herein.

FIG. 2 illustrates examples of user interfaces for skipping autocorrect in text indicating a typographical error, in accordance with one or more implementations as described herein.

FIGS. 3-7 illustrate example methods for skipping autocorrect in text indicating a typographical error in accordance with one or more implementations of the techniques described herein.

FIG. 8 illustrates various components of an example device that may be used to implement the techniques for skipping autocorrect in text indicating a typographical error as described herein.

### DETAILED DESCRIPTION

Implementations of the techniques for skipping autocorrect in text indicating a typographical error may be implemented as described herein. A computing device, such as any type of a wireless device, mobile device, media device, mobile phone, client device, tablet, computing, communication, entertainment, gaming, media playback, and/or any other type of computing, consumer, and/or electronic device may be implemented to perform techniques for skipping autocorrect in text indicating a typographical error, as described herein. In one or more implementations, a computing device includes a text processing application, which can be used to implement aspects of the techniques described herein.

Many types of user devices include word processors, email applications, and various messaging applications, any one or more of which includes integrated spellcheck and autocorrect features. The integrated spellcheck and autocorrect features can help a drafter by quickly detecting and flagging spelling errors, offering corrections, and even predicting an intended word. Today's spellcheck and autocorrect features have become essential and are relied on by users to maintain spelling and grammar accuracy, and to improve their writing. For formal documents and presentations, these enhanced drafting assistance features can be particularly helpful to a user, so as to prevent spelling and/or grammar errors that may otherwise distract an audience or convey a lack of attention to detail. By automatically correcting common spelling mistakes and/or other typographical errors, and by offering suggestions for improvement, modern spellcheckers and autocorrect features can significantly enhance the quality, appearance, and professionalism of written communications.

However, even the most well-intended, enhanced user features designed to simplify and improve user content drafting can have drawbacks. The spellcheck and autocorrect features integrated into word processors, email applications, and various messaging applications may perform some aspects of the tasks for spellcheck and autocorrect too efficiently, and in some instances, without intelligent context. For example, a reviewer of a document or message may find a misspelled word or other form of a typographical error, such as a missing period at the end of a sentence or missing quotation marks, while reviewing a document. The reviewer may then want to send feedback to the drafter of the document for a correction or update. In this instance, the reviewer may want to convey, in the text body of an email or in another type of message, the misspelling of a word or other typographical error by intentionally including the word as it has been misspelled, or by including the typographical error as it appears in the reviewed document. Notably, the reviewer intends the form of the typographical error in the message back to the drafter of the document. However, given how well conventional spellcheck and autocorrect features perform, an intentional misspelling or other type of typographical error included in the text content of a message will most likely be quickly identified and auto-corrected. The conventional spellcheck and autocorrect features are not designed to understand or determine the subtlety of the intended context, and a correction is not the desired message by the reviewer, which may lead to user frustration and a poor user experience.

In aspects of the described techniques, any type of a computing device can include a text processing application that implements features of skipping autocorrect in text indicating a typographical error, as described herein. In context of this disclosure, a typographical error (also commonly referred to as a “typo”) may include any one or more of a misspelled word, incorrect punctuation, a misplaced character, and the like. The text processing application may be independent of and/or integrated into any type of word processor, email application, and/or messaging application. In one or more implementations, a messaging application (e.g., an email drafting application) receives text input, such as entered by a user who is composing a message. The text processing application monitors the text input, performing spellcheck, grammar check, and/or autocorrect of the text input in the draft message. These message drafting and/or text input features may be implemented to check over the draft message after the message has been drafted, or may be implemented to check the text input in the draft message in approximately real-time as the message is being drafted.

In implementations, the text processing application can identify a typographical error in a draft message, such as any type of a misspelled word, a punctuation error, and/or an alternative spelling of a word. The text processing application can then detect that the typographical error (e.g., the misspelled word, the punctuation error, and/or the alternative spelling of a word) is intended in the draft message, and thus, maintain the typographical error in the draft message without auto-correction. In one or more implementations, the text processing application can detect that a typographical error is intended in the draft message based on a context indication in the text input of the draft message. For example, the text processing application may detect a context indication (or context indicator) in the text input of the draft message, such as a word or phrase preceding and/or succeeding the typographical error that indicates the typographical error was intended in the draft message.

The text processing application is then precluded from correcting the misspelled word, the punctuation error, or the alternative spelling of a word in the draft message. For example, the text processing application leaves the error in the draft message as the reviewer of a document intends to send the message back to the drafter of the document, noting the typographical error for correction by the drafter. This is notably different than simply turning-off a spellcheck or grammar checking feature in a conventional text processing system on a device. If these features are disabled, or if some delimiter is defined so that a particular typographical error of a word or phrase is not to be auto-corrected, then the typographical error will persist in all messages and documents that may be drafted on the device.

While features and concepts of the described techniques for skipping autocorrect in text indicating a typographical error is implemented in any number of different devices, systems, environments, and/or configurations, implementations of the techniques for skipping autocorrect in text indicating a typographical error are described in the context of the following example devices, systems, and methods.

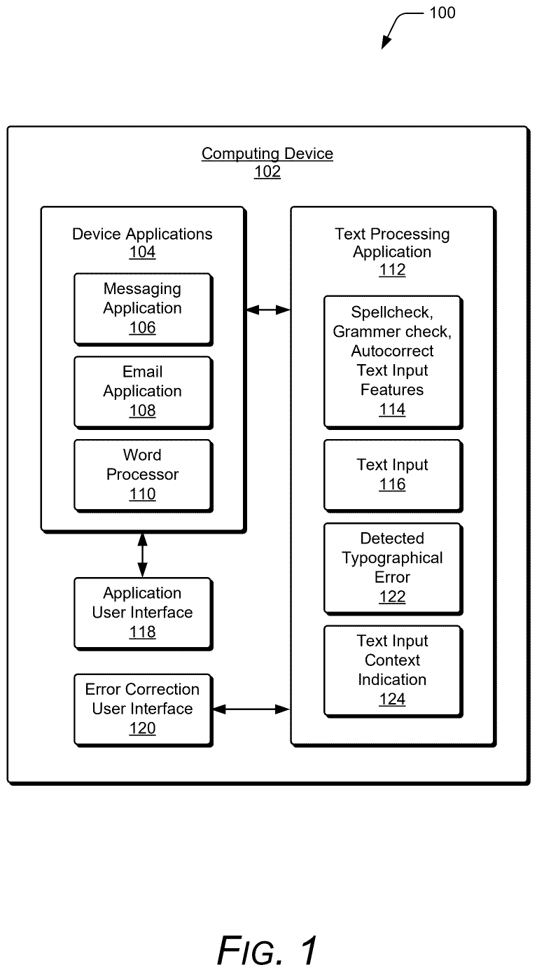

FIG. 1 illustrates an example system 100 for skipping autocorrect in text indicating a typographical error, as described herein. The system 100 includes a computing device 102, such as any type of wireless device, mobile device, media device, mobile phone, client device, tablet, computing, communication, entertainment, gaming, media playback, and/or any other type of computing, consumer, and/or electronic device. The computing device 102 can be implemented with various components, such as a processor system and memory, as well as any number and combination of different components as further described with reference to the example device shown in FIG. 8.

The computing device 102 can include and implement various device applications 104, such as any type of messaging application 106, email application 108, word processor 110, video communication application, cellular communication application, music/audio application, gaming application, media application, social platform applications, and/or any other of the many possible types of various device applications. Many of the device applications 104 have an associated application user interface that is generated and displayed for user interaction and viewing, such as on a display screen of the computing device 102. Generally, an application user interface, or any other type of video, image, graphic, and the like is digital image content that is displayable on the display screen of the computing device 102.

In the example system 100 for skipping autocorrect in text indicating a typographical error, the computing device 102 implements a text processing application 112 (e.g., as a device application). As shown in this example, the text processing application 112 represents functionality (e.g., logic, software, and/or hardware) enabling aspects of the described techniques for skipping autocorrect in text indicating a typographical error. The text processing application 112 can be implemented as computer instructions stored on computer-readable storage media and can be executed by a processor system of the computing device 102. Alternatively, or in addition, the text processing application 112 can be implemented at least partially in hardware of the device.

In one or more implementations, the text processing application 112 includes independent processing, memory, and/or logic components functioning as a computing and/or electronic device integrated with the computing device 102. Alternatively, or in addition, the text processing application 112 can be implemented in software, in hardware, or as a combination of software and hardware components. In this example, the text processing application 112 is implemented as a software application or module, such as executable software instructions (e.g., computer-executable instructions) that are executable with a processor system of the computing device 102 to implement the techniques and features described herein. As a software application or module, the text processing application 112 can be stored on computer-readable storage memory (e.g., memory of a device), or in any other suitable memory device or electronic data storage implemented with the application. Alternatively or in addition, the text processing application 112 is implemented in firmware and/or at least partially in computer hardware. For example, at least part of the text processing application 112 is executable by a computer processor, and/or at least part of the text processing application 112 is implemented in logic circuitry.

In this example system 100, the text processing application 112 may be integrated with any of the various device applications 104, such as the messaging application 106, the email application 108, and/or the word processor 110. In one or more implementations, the text processing application 112 represents the integrated spellcheck, grammar check, and/or autocorrect text input features 114 utilized in the various device applications 104 (e.g., a messaging application, an email application, a word processor). These text input features 114 (also referred to as message drafting features) may be implemented with or integrated into a device application to check over the text input entered into a document or draft message after the document or message has been drafted. Alternatively, the text input features 114 may be implemented to check the text input entered into the document or the draft message in approximately real-time as the document or message is being drafted.

In one or more implementations, the text processing application 112 receives and/or monitors text input 116, such as when a user is composing a message in a user interface 118 of the messaging application 106 or the email application 108, or the user is drafting a document in a user interface 118 of the word processor 110. In some cases, the spellcheck, grammar check, and/or autocorrect features parse and tokenize the individual words of the text input 116, and each word is checked against a dictionary of valid words. If an error is detected, such as a misspelled word, then the misspelled word is flagged or otherwise identified. The system (e.g., the text processing application 112) identifies and classifies the type of error (e.g., as a typo, homophone, etc.), and can suggest one or more corrections, such as based on similarity, phonetics, and/or frequency. The system can then rank suggested corrections based on the context and word frequency. Some conventional systems may simply then proceed to autocorrect a misspelled word or other type of typographical error that has been identified in the text input.

In some instances, the text processing application 112 may be implemented to display some type of an error correction user interface 120 that indicates a misspelled word, punctuation error, and/or other type of a typographical error 122, which has been detected in the text input 116 of a draft message or document. A user of the device (e.g., the person entering the input text of the draft message) can then accept, ignore, or modify corrections as indicated in the error correction user interface 120. However, this may also cause the user to have to spend more time selecting (e.g., clicking in the user interface) to indicate that the system should ignore the misspelled word, punctuation error, and/or other type of a typographical error 122, and otherwise having to indicate that the draft message (e.g., an email message) should be communicated as-intended with the typographical error included as an indication to the message recipient that the typographical error needs to be corrected.

In an example, Amit is a prolific inventor who spends much of his time reviewing patent application documents drafted by others. His role involves scrutinizing these documents thoroughly to identify drafting errors, including misspellings and typographical mistakes, and providing detailed review comments and feedback to the drafters of the documents. His attention to detail ensures that his patent applications meet the necessary standards before approval. As unlikely as it seems, Amit may identify a misspelling or other typographical error in one of the many patent applications that Dave drafts for him. Amit may then prepare a review summary in an email message to indicate a misspelled word or other mistake. For example, Amit may type in his message “There is a misspelled word ‘artificcial’ in the document”, or may include an indication of a typo, such as “This sentence has a typo and does not end with a period—‘The systm generates an interface’—Can you please fix these?” Further, as a matter of convenience, Amit may copy and paste the exact section of text from the document that he is reviewing into his draft message back to the drafter of the document. This is convenient for Amit to quickly include an indication of the typographical error in his draft message, as well as a convenience for the recipient of the message who can simply copy and search for the particular typographical error in a multi-page document, and easily locate the mistake.

Although Amit has indicated that there is a misspelled word and a needed punction correction in his draft message, the spellcheck and autocorrect features of his conventional system will likely correct the errors in his email message, which is not his intended context. The misspelled word will be corrected to its correct spelling “artificial” in the email message, as will the misspelled word “system.” Similarly, the punctuation error will be corrected to “The system generates an interface.” with spellcheck or autocorrect properly adding the period at the end of the sentence.

In aspects of the described techniques, the text processing application 112 can be implemented to monitor the text input 116 for a typographical error 122 in a draft message. For example, the text processing application 112 receives and/or monitors the text input 116, such as when a user is composing a message in a user interface 118 of the messaging application 106 or the email application 108, or the user is drafting a document in a user interface 118 of the word processor 110. The text processing application 112 performs any one or combination of spellcheck, grammar check, or autocorrect and monitors the text input. A typographical error 122 may be detected in the text input 116 as a misspelled word, as a punctuation error, or as an alternative spelling of a word. As an example of an alternative spelling, a word may have a particular spelling in a current language version, and although spelled differently but correctly in another language version, may be flagged as a typographical error 122 in the text input 116 of the draft message. For example, the British English spelling of the word “colour” may be indicated as a typographical error 122 (e.g., a misspelled word) of the American English version of the word “color”, even though the user intends to use the word “colour” in a draft message.

The text processing application 112 can detect that a typographical error 122 is intended in a draft message, and then maintain the typographical error in the draft message without auto-correction. In implementations, the text processing application 112 can detect that a misspelled word is intended to be misspelled in the draft message, that a punctuation error is intended in the draft message, and/or that an alternative spelling of a word is intended in the draft message. To detect that the misspelled word, the punctuation error, and/or the alternative spelling of a word is intended in the text input 116 of the draft message, the text processing application 112 can identify or detect a text input context indication 124 in the text input of the draft message. In implementations, a context indication 124 that a typographical error 122 is intended in the text input 116 may detected as a word and/or phrase in the text input that precedes the misspelled word, the punctuation error, and/or the alternative spelling of a word. A word and/or phrase may precede the misspelled word in the text input 116 to indicate that the misspelled word is intended. Similarly, a word and/or phrase may precede the punctuation error in the text input 116 to indicate that the punctuation error is intended. Similarly, a word and/or phrase may precede the alternative spelling of the word in the text input to indicate that the alternative spelling of the word is intended.

In implementations, the text processing application 112 monitors the text input 116 for an indication (e.g., as a word and/or phrase) that a typographical error 122 may be intended in the text input of a draft message. For example, a user (e.g., the person drafting the message) may input text in the draft message as “There is a typo in paragraph [0010], ‘occuurring’—please update in your document.” The text processing application 112 can detect the word “typo” as a context indication 124 that a detected typographical error 122 may be following thereafter, which in this case, is the misspelled word “occuurring.” In this example, the word “typo” is detected in the text input 116 as the context indication 124 that there is an intended typographical error in the draft message. In implementations, any one or combination of words and/or phrases, such as typo, mistake, error, alternative, alternate, correction, correct, misspelled, misspelling, incorrect, fix, update, and/or any other type of word or phrase that may be detected as a context indication 124 that a typographical error 122 (e.g., a misspelled word, punction error, and/or an alternative spelling of a word) is intended in the text input of a draft message. The text processing application 112 is then precluded from correcting the detected typographical error 122 in the draft message, thus allowing the user to send the message back to the drafter of a document, noting the typographical error for correction by the drafter.

As described, the text processing application 112 can detect a context indication 124 (e.g., “there is a typo”) that there is an intended typographical error 122 in a draft message. In one or more implementations, the text processing application 112 can then associate the context indication 124 to indicate the next misspelled word or punctuation error as the intended typographical error 122 in the text input 116 in the draft message. Additionally, or alternatively, the text processing application 112 may associate the context indication 124 to indicate an intended typographical error 122 within a certain range of subsequent words, or within a specified number of words after the context indication 124.

For example, a user may enter the text input 116 in a draft message as “There is a typo in paragraph [0010]. Other than that, there is just the one punctuatin error in paragraph [0025].” In this example, the text processing application 112 may detect the word “typo” as a context indication 124 that the message includes an intended typographical error. However, the user who drafts the message did not include an example of what the “typo in paragraph [0010]” actually is. Rather, given that there is a misspelled word “punctuatin” in the draft message, referring to a different paragraph in the reviewed document, and the misspelled word is not within five words (for example) and/or is not in the same sentence as the word “typo”, the text processing application 112 can disregard the detected context indication 124 of the word “typo” and autocorrect the misspelled word in the draft message to “punctuation.” In another example, the user may enter the text input 116 in a draft message as “There is a typo in paragraph [0010], where AbbB should be AppB.” In this context both “AbbB” and “AppB” are indicated or detected as typographical errors 122. However, both the “AbbB” and “AppB” are included in the draft message in the context intended by the user in the message, and “AppB” is also the correct and intended spelling.

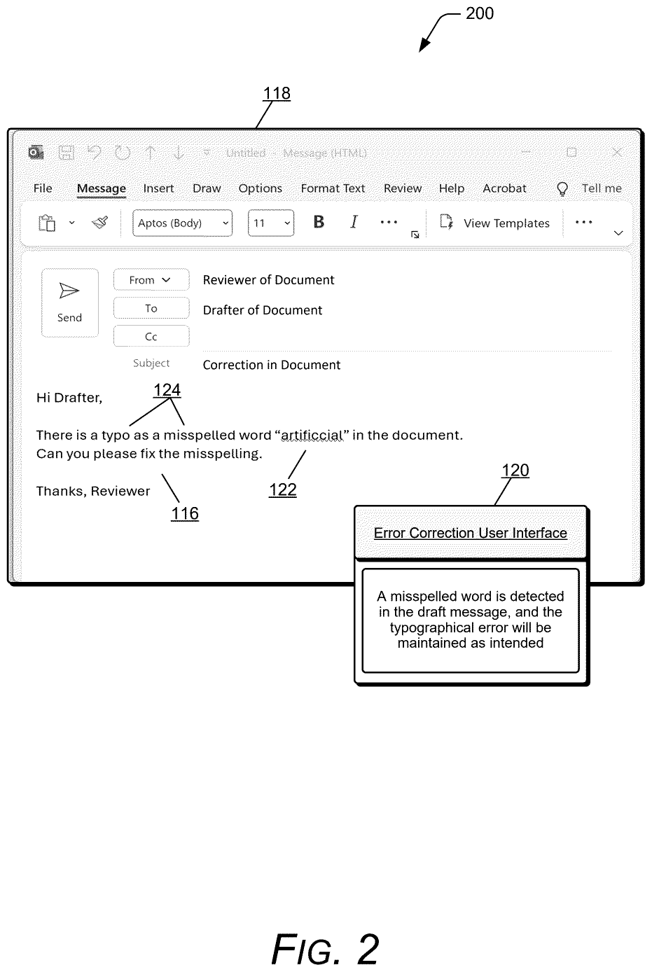

FIG. 2 illustrates examples 200 of user interfaces in aspects of skipping autocorrect in text indicating a typographical error, as described herein. In these examples 200, an application user interface 118 of the email application 108 is illustrated as an email message (e.g., a draft message) that is being drafted by a reviewer of a document, intending to return a review message back to a drafter of the document. The reviewer enters the text input 116 in the email message, which indicates that the reviewer has found a misspelled word in the document and is requesting that the drafter of the document fix the noted error. For example, the reviewer has included the text input 116 of “There is a typo as a misspelled word ‘artificcial’in the document.”

In this example, the text processing application 112 receives and/or monitors the text input 116, such as when the user is composing the draft message in the user interface 118 of the email application 108. The text processing application 112 (e.g., the spellcheck, grammar check, and/or autocorrect features) identify the typographical error 122 (e.g., the misspelled word) in the text input 116 in the draft message. Additionally in this example, the text processing application 112 has identified or detected text input context indication(s) 124 in the text input 116 of the draft message. For example, the text processing application 112 detects the context indications 124 as a word (e.g., “typo”) and/or a phrase (e.g., “misspelled word”) in the text input 116, and the context indications precede the misspelled word “artificcial” in the draft message. In implementations, the context indication(s) 124 indicate to the text processing application 112 that the typographical error 122 is intended in the text input 116 of the draft message. Further in this example, the text processing application 112 may initiate to display an error correction user interface 120 that indicates the misspelled word has been detected in the text input 116 of the draft message, and that the typographical error will be maintained as intended.

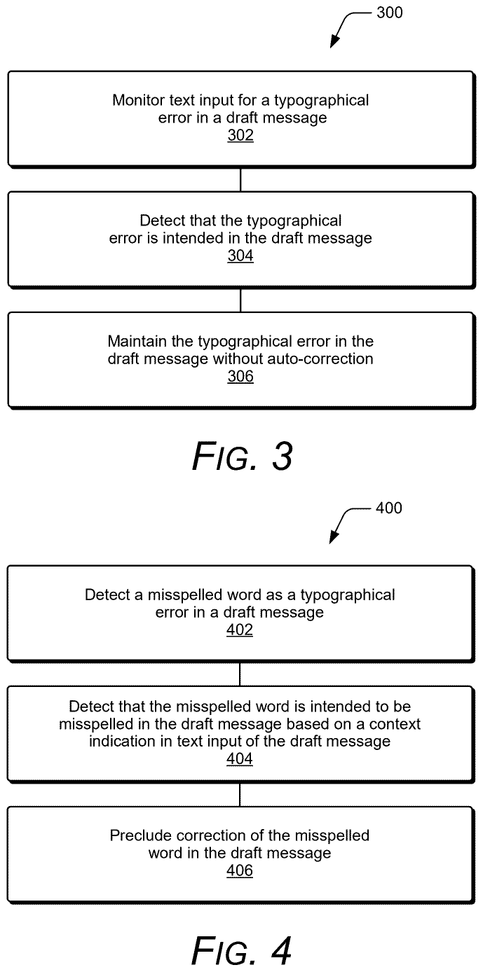

Example methods 300, 400, 500, 600, and 700 are described with reference to respective FIGS. 3-7 in accordance with one or more implementations of skipping autocorrect in text indicating a typographical error, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 for skipping autocorrect in text indicating a typographical error. The order in which the method is described is not intended to be construed as a limitation, and any number or combination of the described method operations may be performed in any order to perform a method, or an alternate method.

At 302, text input is monitored for a typographical error in a draft message. For example, the text processing application 112 receives and/or monitors text input 116 for a typographical error 122 in a draft message, such as any type of a misspelled word, a punctuation error, or an alternative spelling of a word.

At 304, the typographical error is detected as being intended in the draft message. For example, the text processing application 112 detects that the typographical error 122 is intended in the draft message. To detect that a misspelled word, a punctuation error, and/or an alternative spelling of a word is intended in the text input 116 of a draft message, the text processing application 112 can identify or detect a text input context indication 124 in the text input of the draft message. In implementations, a context indication 124 that a typographical error 122 is intended in the text input 116 may detected as a word and/or phrase in the text input that precedes the typographical error.

At 306, the typographical error is maintained in the draft message without auto-correction. For example, the text processing application 112 maintains the typographical error 122 in the text input 116 of the draft message without auto-correction. The text processing application 112 can associate the context indication 124 that indicates the next misspelled word or punctuation error is an intended typographical error 122 in the text input 116 in the draft message. The text processing application 112 then maintains the typographical error in the draft message without correction so that the drafter can send the message to a recipient with the intended typographical error maintained as an error in the message.

FIG. 4 illustrates example method(s) 400 for skipping autocorrect in text indicating a typographical error. The order in which the method is described is not intended to be construed as a limitation, and any number or combination of the described method operations may be performed in any order to perform a method, or an alternate method.

At 402, a misspelled word is detected as a typographical error in a draft message. For example, the text processing application 112 detects a misspelled word as a typographical error 122 in the text input 116 of a draft message. At 404, the misspelled word is detected as being intended to be misspelled in the draft message based on a context indication in text input of the draft message. For example, the text processing application 112 detects that the misspelled word is intended to be misspelled in the draft message based on a context indication 124 in the text input 116 of the draft message. In implementations, the context indication 124 is detected as a word and/or phrase in the text input that precedes the misspelled word. At 406, correction of the misspelled word is precluded in the draft message. For example, the text processing application 112 precludes correction of the misspelled word in the draft message. Accordingly, the misspelled word is maintained as a typographical error in the draft message as intended by the user (e.g., the drafter of the message).

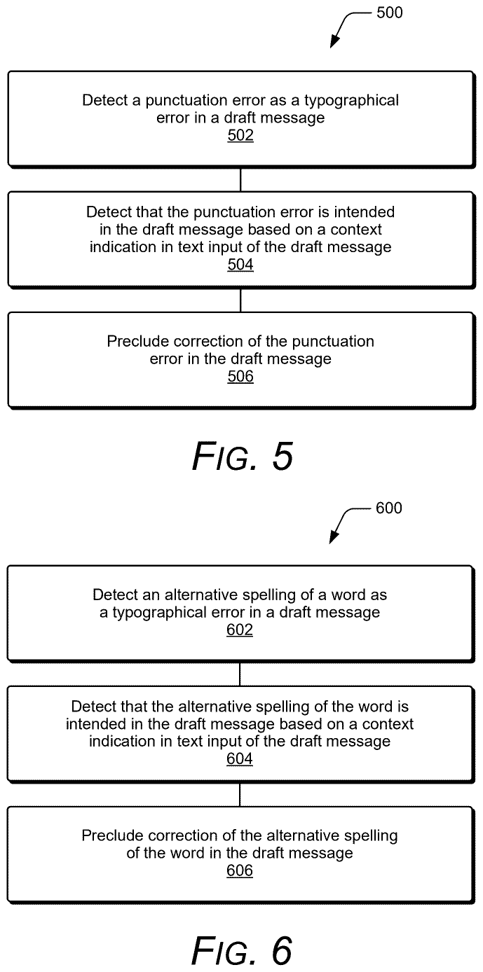

FIG. 5 illustrates example method(s) 500 for skipping autocorrect in text indicating a typographical error. The order in which the method is described is not intended to be construed as a limitation, and any number or combination of the described method operations may be performed in any order to perform a method, or an alternate method.

At 502, a punctuation error is detected as a typographical error in a draft message. For example, the text processing application 112 detects a punctuation error as a typographical error 122 in the text input 116 of a draft message. At 504, the punctuation error is detected as being intended in the draft message based on a context indication in text input of the draft message. For example, the text processing application 112 detects that the punctuation error is intended in the draft message based on a context indication 124 in the text input 116 of the draft message. In implementations, the context indication 124 is detected as a word and/or phrase in the text input that precedes the punctuation error. At 506, correction of the punctuation error is precluded in the draft message. For example, the text processing application 112 precludes correction of the punctuation error in the draft message. Accordingly, the punctuation error is maintained as a typographical error in the draft message as intended by the user (e.g., the drafter of the message).

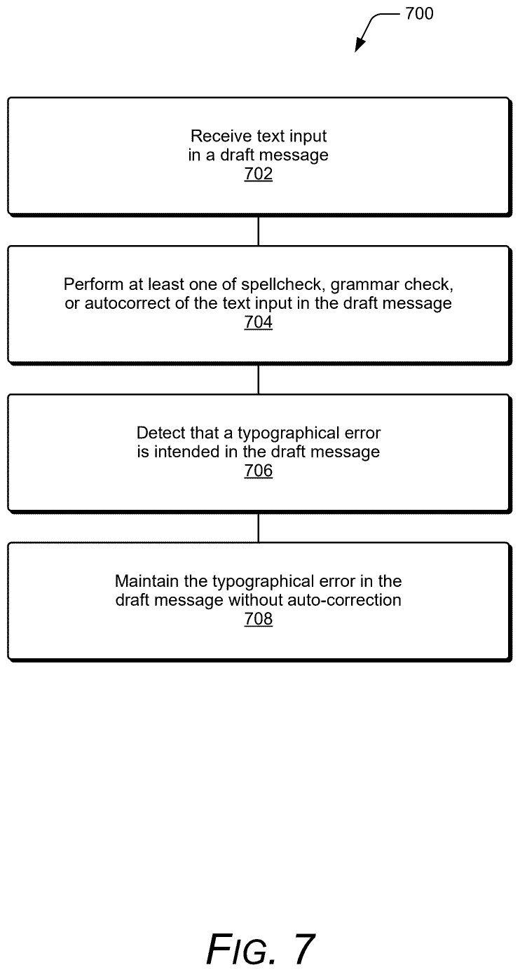

FIG. 6 illustrates example method(s) 600 for skipping autocorrect in text indicating a typographical error. The order in which the method is described is not intended to be construed as a limitation, and any number or combination of the described method operations may be performed in any order to perform a method, or an alternate method.

At 602, an alternative spelling of a word is detected as a typographical error in a draft message. For example, the text processing application 112 detects an alternative spelling of a word as a typographical error 122 in the text input 116 of a draft message. At 604, the alternative spelling of the word is detected as being intended in the draft message based on a context indication in text input of the draft message. For example, the text processing application 112 detects that the alternative spelling of the word is intended in the draft message based on a context indication 124 in the text input 116 of the draft message. In implementations, the context indication 124 is detected as a word and/or phrase in the text input that precedes the alternative spelling of the word. At 606, correction of the alternative spelling of the word is precluded in the draft message. For example, the text processing application 112 precludes correction of the alternative spelling of the word in the draft message. Accordingly, the alternative spelling of the word is maintained as a typographical error in the draft message as intended by the user (e.g., the drafter of the message).

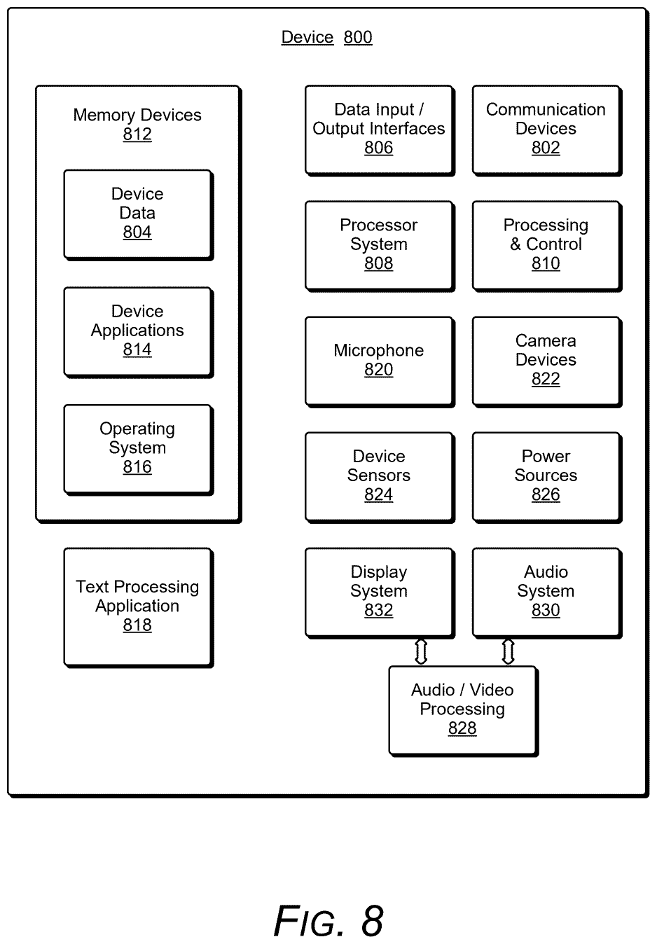

FIG. 7 illustrates example method(s) 700 for skipping autocorrect in text indicating a typographical error. The order in which the method is described is not intended to be construed as a limitation, and any number or combination of the described method operations may be performed in any order to perform a method, or an alternate method.

At 702, text input is received in a draft message. For example, the text processing application 112 receives and/or monitors text input 116 in a draft message, such as when a user is composing a message in a user interface 118 of the messaging application 106 or the email application 108, or the user is drafting a document in a user interface 118 of the word processor 110. At 704, at least one of spellcheck, grammar check, or autocorrect of the text input is performed in the draft message. For example, the text processing application 112 initiates to perform at least one of the spellcheck, grammar check, or autocorrect text input features 114 of the text input 116 in the draft message.

At 706, a typographical error is detected as being intended in the draft message. For example, the text processing application 112 detects that the typographical error 122 is intended in the draft message. To detect that a misspelled word, a punctuation error, and/or an alternative spelling of a word is intended in the text input 116 of a draft message, the text processing application 112 can identify or detect a text input context indication 124 in the text input of the draft message. In implementations, a context indication 124 that a typographical error 122 is intended in the text input 116 may detected as a word and/or phrase in the text input that precedes the typographical error.

At 708, the typographical error is maintained in the draft message without auto-correction. For example, the text processing application 112 maintains the typographical error 122 in the text input 116 of the draft message without auto-correction. Accordingly, the typographical error 122 (e.g., the misspelled word, the punctuation error, and/or the alternative spelling of a word) is maintained as the typographical error in the draft message as intended by the user (e.g., the drafter of the message). The message can then be communicated as-intended with the typographical error included as an indication to a message recipient that the typographical error can be corrected in a document of the message recipient.

FIG. 8 illustrates various components of an example device 800, which can implement aspects of the techniques and features for skipping autocorrect in text indicating a typographical error, as described herein. The example device 800 may be implemented as any of the devices described with reference to the previous FIGS. 1-7, such as any type of a wireless device, mobile device, mobile phone, flip phone, client device, companion device, display device, tablet, computing, communication, entertainment, gaming, media playback, and/or any other type of computing, consumer, and/or electronic device. For example, the computing device 102 described with reference to FIGS. 1-7 may be implemented as the example device 800.

The example device 800 can include various, different communication devices 802 that enable wired and/or wireless communication of device data 804 with other devices. The device data 804 can include any of the various devices data and content that is generated, processed, determined, received, stored, and/or communicated from one computing device to another. Generally, the device data 804 can include any form of audio, video, image, graphics, and/or electronic data that is generated by applications executing on a device. The communication devices 802 can also include transceivers for cellular phone communication and/or for any type of network data communication.

The example device 800 can also include various, different types of data input/output (I/O) interfaces 806, such as data network interfaces that provide connection and/or communication links between the devices, data networks, and other devices. The data I/O interfaces 806 may be used to couple the device to any type of components, peripherals, and/or accessory devices, such as a computer input device that may be integrated with the example device 800. The I/O interfaces 806 may also include data input ports via which any type of data, information, media content, communications, messages, and/or inputs may be received, such as user inputs to the device, as well as any type of audio, video, image, graphics, and/or electronic data received from any content and/or data source.

The example device 800 includes a processor system 808 of one or more processors (e.g., any of microprocessors, controllers, and the like) and/or a processor and memory system implemented as a system-on-chip (SoC) that processes computer-executable instructions. The processor system 808 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 810. The example device 800 may also include any type of a system bus or other data and command transfer system that couples the various components within the device. A system bus can include any one or combination of different bus structures and architectures, as well as control and data lines.

The example device 800 also includes memory and/or memory devices 812 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 812 include volatile memory and non-volatile memory, fixed and removable media devices, and any suitable memory device or electronic data storage that maintains data for computing device access. The memory devices 812 can include various implementations of random-access memory (RAM), read-only memory (ROM), flash memory, and other types of storage media in various memory device configurations. The example device 800 may also include a mass storage media device.

The memory devices 812 (e.g., as computer-readable storage memory) provide data storage mechanisms, such as to store the device data 804, other types of information and/or electronic data, and various device applications 814 (e.g., software applications and/or modules). For example, an operating system 816 may be maintained as software instructions with a memory device 812 and executed by the processor system 808 as a software application. The device applications 814 may also include a device manager, such as any form of a control application, software application, signal-processing and control module, code that is specific to a particular device, a hardware abstraction layer for a particular device, and so on.

In this example, the device 800 includes a text processing application 818 that implements various aspects of the described features and techniques described herein. The text processing application 818 may be implemented with hardware components and/or in software as one of the device applications 814, such as when the example device 800 is implemented as the computing device 102 described with reference to FIGS. 1-7. An example of the text processing application 818 is the text processing application 112 implemented by the computing device 102, such as a software application and/or as hardware components in the computing device. In implementations, the text processing application 818 may include independent processing, memory, and logic components as a computing and/or electronic device integrated with the example device 800.

The example device 800 can also include a microphone 820 (e.g., to capture audio and/or an audio recording) and/or camera devices 822 (e.g., to capture digital images and/or video images), as well as device sensors 824, such as may be implemented as components of an inertial measurement unit (IMU). The device sensors 824 may be implemented with various sensors, such as a gyroscope, an accelerometer, and/or other types of motion sensors to sense motion of the device. The device sensors 824 can generate sensor data vectors having three-dimensional parameters (e.g., rotational vectors in x, y, and z-axis coordinates) indicating location, position, acceleration, rotational speed, and/or orientation of the device. The example device 800 can also include one or more power sources 826, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 800 can also include an audio and/or video processing system 828 that generates audio data for an audio system 830 and/or generates display data for a display system 832. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 800. Alternatively, the audio system and/or the display system are external, peripheral components to the example device.

Although implementations for skipping autocorrect in text indicating a typographical error have been described in language specific to features and/or methods, the appended claims are not necessarily limited to the specific features or methods described. Rather, the specific features and methods are disclosed as example implementations for skipping autocorrect in text indicating a typographical error, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A computing device, comprising at least one memory and at least one processor coupled with the at least one memory and configured to, capable of, or operable to cause the computing device to monitor text input for a typographical error in a draft message; detect that the typographical error is intended in the draft message; and maintain the typographical error in the draft message without auto-correction.

Alternatively, or in addition to the above-described computing device, any one or combination of: a text processing application that performs at least one of spellcheck, grammar check, or autocorrect is configured to, capable of, or operable to monitor the text input. The typographical error is detected as a misspelled word; and a text processing application is configured to, capable of, or operable to detect that the misspelled word is intended to be misspelled in the draft message, and precludes correction of the misspelled word. To detect that the misspelled word is intended, the text processing application is configured to, capable of, or operable to detect a context indication in the text input of the draft message. The context indication is at least one of a word or phrase preceding or succeeding the misspelled word in the text input to indicate that the misspelled word is intended. The typographical error is detected as a punctuation error; and a text processing application is configured to, capable of, or operable to detect that the punctuation error is intended in the draft message, and precludes correction of the punctuation error. To detect that the punctuation error is intended, the text processing application is configured to, capable of, or operable to detect a context indication in the text input of the draft message. The context indication is at least one of a word or phrase preceding or succeeding the punctuation error in the text input to indicate that the punctuation error is intended. The typographical error is detected as an alternative spelling of a word; and a text processing application is configured to, capable of, or operable to detect that the alternative spelling of the word is intended in the draft message, and precludes correction of the alternative spelling. To detect that the alternative spelling of the word is intended, the text processing application is configured to, capable of, or operable to detect a context indication in the text input of the draft message. The context indication is at least one of a word or phrase preceding or succeeding the alternative spelling of the word in the text input to indicate that the alternative spelling of the word is intended.

A method, comprising monitoring text input for a typographical error in a draft message; detecting that the typographical error is intended in the draft message; and maintaining the typographical error in the draft message without auto-correction.

Alternatively, or in addition to the above-described method, any one or combination of: the typographical error is detected as a misspelled word, and the method including detecting that the misspelled word is intended to be misspelled in the draft message; and precluding correction of the misspelled word. The method including detecting a context indication in the text input of the draft message, where the context indication is at least one of a word or phrase preceding or succeeding the misspelled word in the text input to indicate that the misspelled word is intended. The typographical error is detected as a punctuation error, and the method including detecting that the punctuation error is intended in the draft message; and precluding correction of the punctuation error. The method including detecting a context indication in the text input of the draft message, where the context indication is at least one of a word or phrase preceding or succeeding the punctuation error in the text input to indicate that the punctuation error is intended. The typographical error is detected as an alternative spelling of a word, and the method including detecting that the alternative spelling of the word is intended in the draft message; and precluding correction of the alternative spelling. The method including detecting a context indication in the text input of the draft message, where the context indication is at least one of a word or phrase preceding or succeeding the alternative spelling of the word in the text input to indicate that the alternative spelling of the word is intended.

A system, comprising a messaging application configured to receive text input in a draft message; a text processing application configured to, capable of, or operable to perform at least one of spellcheck, grammar check, or autocorrect of the text input in the draft message; detect that a typographical error is intended in the draft message; and maintain the typographical error in the draft message without auto-correction.

Alternatively, or in addition to the above-described system, any one or combination of: to detect that the typographical error is intended, the text processing application is configured to, capable of, or operable to detect a context indication in the text input of the draft message, and where the context indication is at least one of a word or phrase preceding or succeeding the typographical error to indicate that the typographical error is intended.

1. A computing device, comprising:
at least one memory; and
at least one processor coupled with the at least one memory and operable to cause the computing device to:
monitor text input for a typographical error in a draft message;
detect that the typographical error is intended in the draft message; and
maintain the typographical error in the draft message without auto-correction.

2. The computing device of claim 1, wherein a text processing application that performs at least one of spellcheck, grammar check, or autocorrect is operable to monitor the text input.

3. The computing device of claim 1, wherein:
the typographical error is detected as a misspelled word; and
a text processing application is operable to detect that the misspelled word is intended to be misspelled in the draft message, and precludes correction of the misspelled word.

4. The computing device of claim 3, wherein, to detect that the misspelled word is intended, the text processing application is operable to detect a context indication in the text input of the draft message.

5. The computing device of claim 4, wherein the context indication is at least one of a word or phrase preceding or succeeding the misspelled word in the text input to indicate that the misspelled word is intended.

6. The computing device of claim 1, wherein:
the typographical error is detected as a punctuation error; and
a text processing application is operable to detect that the punctuation error is intended in the draft message, and precludes correction of the punctuation error.

7. The computing device of claim 6, wherein, to detect that the punctuation error is intended, the text processing application is operable to detect a context indication in the text input of the draft message.

8. The computing device of claim 7, wherein the context indication is at least one of a word or phrase preceding or succeeding the punctuation error in the text input to indicate that the punctuation error is intended.

9. The computing device of claim 1, wherein:
the typographical error is detected as an alternative spelling of a word; and
a text processing application is operable to detect that the alternative spelling of the word is intended in the draft message, and precludes correction of the alternative spelling.

10. The computing device of claim 9, wherein, to detect that the alternative spelling of the word is intended, the text processing application is operable to detect a context indication in the text input of the draft message.

11. The computing device of claim 10, wherein the context indication is at least one of a word or phrase preceding or succeeding the alternative spelling of the word in the text input to indicate that the alternative spelling of the word is intended.

12. A method, comprising:
monitoring text input for a typographical error in a draft message;
detecting that the typographical error is intended in the draft message; and
maintaining the typographical error in the draft message without auto-correction.

13. The method of claim 12, wherein:
the typographical error is detected as a misspelled word;
the method further comprising:
detecting that the misspelled word is intended to be misspelled in the draft message; and
precluding correction of the misspelled word.

14. The method of claim 13, further comprising detecting a context indication in the text input of the draft message, wherein the context indication is at least one of a word or phrase preceding or succeeding the misspelled word in the text input to indicate that the misspelled word is intended.

15. The method of claim 12, wherein:
the typographical error is detected as a punctuation error;
the method further comprising:
detecting that the punctuation error is intended in the draft message; and
precluding correction of the punctuation error.

16. The method of claim 15, further comprising detecting a context indication in the text input of the draft message, wherein the context indication is at least one of a word or phrase preceding or succeeding the punctuation error in the text input to indicate that the punctuation error is intended.

17. The method of claim 12, wherein:
the typographical error is detected as an alternative spelling of a word;
the method further comprising:
detecting that the alternative spelling of the word is intended in the draft message; and
precluding correction of the alternative spelling.

18. The method of claim 17, further comprising detecting a context indication in the text input of the draft message, wherein the context indication is at least one of a word or phrase preceding or succeeding the alternative spelling of the word in the text input to indicate that the alternative spelling of the word is intended.

19. A system, comprising:
a messaging application configured to receive text input in a draft message;
a text processing application operable to:
perform at least one of spellcheck, grammar check, or autocorrect of the text input in the draft message;
detect that a typographical error is intended in the draft message; and
maintain the typographical error in the draft message without auto-correction.

20. The system of claim 19, wherein, to detect that the typographical error is intended, the text processing application is operable to detect a context indication in the text input of the draft message, and wherein the context indication is at least one of a word or phrase preceding or succeeding the typographical error to indicate that the typographical error is intended.
